(19) United States
(12) Patent Application Publication
(10) Pub. No.: US 2015/0154293 A1
(43) Pub. Date: Jun. 4, 2015

(54) CLOUD SYSTEM AND CLOUD RESOURCE ALLOCATION METHOD

(71) Applicants: INVENTEC CORPORATION, Taipei (TW); Inventec (Pudong) Technology Corporation, Shanghai (CN)

(72) Inventor: Ying-Chih LU, Taipei (TW)

(73) Assignees: INVENTEC CORPORATION, Taipei (TW); Inventec (Pudong) Technology Corporation, Shanghai (CN)

(21) Appl. No.: 14/242,527

(22) Filed: Apr. 1, 2014

(30) Foreign Application Priority Data
Nov. 29, 2013 (CN) 201310628365.4

(51) Int. Cl. G06F 17/30

(52) U.S. Cl. CPC G06F 17/30864; G06F 17/30477

(57) ABSTRACT

The disclosure provides a cloud system and a cloud resource allocation method, which performs a cloud resource request file according to a user identity, performs a command, and record information, generated by performing at least one service related to the command, into a cloud resource log file.

### CROSS-REFERENCE TO RELATED APPLICATIONS

This non-provisional application claims priority under 35 U.S.C. §119(a) on Patent Application No(s). 201310628365.4 filed in China on Nov. 29, 2013, the entire contents of which are hereby incorporated by reference.

### BACKGROUND OF THE INVENTION

1. Technical Field of the Invention

The disclosure relates to a cloud system and a cloud resource allocation method, and more particularly to a method of allocating cloud resources according to user identities.

2. Description of the Related Art

Because E-business has become very common with the rapid developed information technology and general personal computers can not satisfy this demand for E-business, servers with a high computing capability are invented to satisfy this demand. Moreover, with the requirement of the market, a large server system (e.g. a container data center) having many mono-servers is replacing a server system having only one mono-server. The hosts of these mono-servers are disposed in a rack system and are managed by a system management terminal via a rack management controller in the rack system.

However, different users require different resources in the server system. It is necessary to efficiently provide users with corresponding resources according to their requirements in the server system.

### SUMMARY OF THE INVENTION

The disclosure provides a cloud system according to one of exemplary embodiments, and the cloud system includes: an information database, configured to store user information; a main control device, electrically connected to the information database and configured to acquire a cloud resource request file from the information database according to a name or category of a user; a virtual machine database, configured to store at least one virtual machine image file; and a cloud service provider, electrically connected to the main control device and the virtual machine database, and configured to acquire the at least one virtual machine image file from the virtual machine database according to the cloud resource request file, to provide a cloud service corresponding to the cloud resource request file.

The disclosure also provides a cloud resource allocation method according to one of the exemplary embodiments, and the cloud resource allocation method includes: processing a cloud resource request file according to a user identity to acquire resources from a cloud system; performing a command; and recording information, which is generated by performing at least one service related to the command, into a cloud resource log file.

### BRIEF DESCRIPTION OF THE DRAWINGS

The present disclosure will become more fully understood from the detailed description given herein below for illustration only and thus does not limit the present disclosure, wherein:

FIG. 1 is a block diagram of a cloud system in one of exemplary embodiments of the disclosure;

FIG. 2 is a flowchart of a cloud resource allocation method in one of exemplary embodiments of the disclosure;

FIG. 3 is a flowchart of the step S120 in FIG. 2 in one of the exemplary embodiments;

FIG. 4 is a flowchart of the step S120 in FIG. 2 in one of the exemplary embodiments;

FIG. 5 is a flowchart of the step S130 in FIG. 2 in one of the exemplary embodiments;

FIG. 6 is a flowchart of the step S133 in FIG. 5 in one of the exemplary embodiments;

FIG. 7 is a flowchart of the step S135 in FIG. 5 in one of the exemplary embodiments; and

FIG. 8 is a flowchart of the step S137 in FIG. 5 in one of the exemplary embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

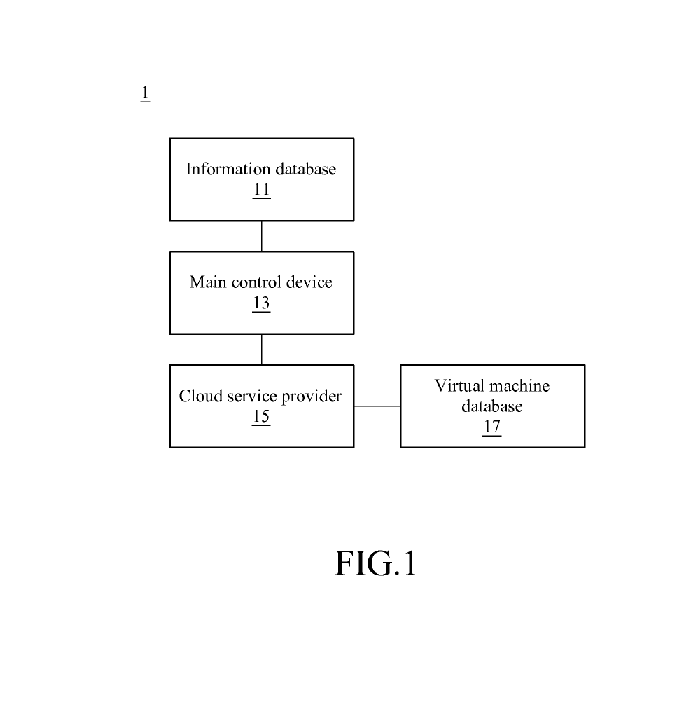

In the disclosure, a cloud resource allocation method is performed by a cloud system as shown in FIG. 1. FIG. 1 is a block diagram of a cloud system in one of exemplary embodiments of the disclosure. The cloud system 1 includes an information database 11, a main control device 13, a cloud service provider 15 and a VM image file database (or called VM database) 17. The main control device 13 electrically connects to the information database 11 and the cloud service provider 15, and the cloud service provider 15 electrically connects to the VM image file database 17.

The information database 11 stores data related to users and tenants. In one exemplary embodiment, tenant data (i.e. cloud resource request files) includes data specifying resources tenants can use, and data specifying resources the tenant frequently uses. In one exemplary embodiment, user data (i.e. cloud resource request files of users) includes data specifying tenants users respectively belong to, data specifying which department in the tenant the user stays, data specifying resources the user can use, and data specifying resources the user frequently uses. The resource here can be, for example, a VM name, a VM size (e.g. a number of virtual central processing units (CPU) or a memory capacity), a volume size required by a VM, or a network security policy (e.g. a network firewall policy or assess codes) for VM's.

The VM image file database 17 stores VM image files. When the cloud system 1 needs to provide a user with a VM cloud service (or called as a cloud service), the cloud system 1 acquires a corresponding VM image file from the VM image file database 17 and uploads the acquired VM image file to the cloud service provider 15. The cloud service provider 15 provides a VM, loads the VM image file into a physical computing device (e.g. a physical host or a computing device in a distributed computing array), and transmits the computing result of the VM to a computer or mobile device of the user.

The information database 11 and the VM image file database 17 can be, for example, physical storage devices (e.g. non-volatile storage media such as hard disk drivers, tapes, or optic disks), or can be one storage section in a storage device, and the disclosure will not be limited thereto.

The main control device 13 controls the cloud service provider 15 according to attitudes (or identities) of users to provide corresponding cloud services or resources to the users. In one exemplary embodiment, when a user enters into the cloud system 1, the main control device 13 determines whether there is any cloud resource request file related to the user in the information database 11, to determine whether this user is a new one. If this user is not a new one, the main control device 13 transmits the cloud resource request file related to the user to the cloud service provider 15, to control the cloud service provider 15 to provide the user with the corresponding cloud service. If this user is a new one (i.e. there is not any cloud resource request files related to this user in the information database 11), the main control device 13 will request the user to input some basic information. The method of requesting the user to input the basic information includes to sequentially ask the user to provide one or more pieces of basic information about, for example, a department (i.e. the tenant or the department in the tenant), position or category (related to the required cloud resource) of the user by inquiring the user or providing dialog boxes of a graphical user interface (GUI).

Then, the main control device 13 converts the basic information of the user into a new cloud resource request file related to the user, and confirms whether there is any could resource (i.e. VM image file) related to the new cloud resource request file. In one exemplary embodiment, the confirming method can be to check whether, in the information database 11, there are other existed cloud resource request files specifying this corresponding VM image file, or be to send a search inquiry to the cloud service provider 15. If there is not this VM image file, the main control device 13 adds an establishing command (or called as image file establishing command) for adding or uploading a new VM image file, into the cloud resource request file. Therefore, when the cloud resource request file related to this user is performed at the first time, the cloud service provider 15 can automatically search for at least one VM image file in the VM image file database 17 and then upload the at least one VM image file to the cloud service provider 15.

The main control device 13 transmits the cloud resource request file related to this user to the cloud service provider 15, to control the cloud service provider 15 to provide this user with a corresponding cloud service and resource corresponding to the cloud resource request file. Subsequently, the main control device 13 sends the user an email or instant message including the resource information (e.g. a network security policy, a assess code, a public internet protocol (IP) address, a private IP address, a volume size, a storage name, a host name, a size, an image file name, an operation system (OS) name, a physical machine or their any possible combination for a VM) generated by performing the cloud service. In this way, the user can use and control the VM according to the resource information. In this embodiment, the main control device 13 can be, for example, a server with a computing capability, or be a main program executed by a server.

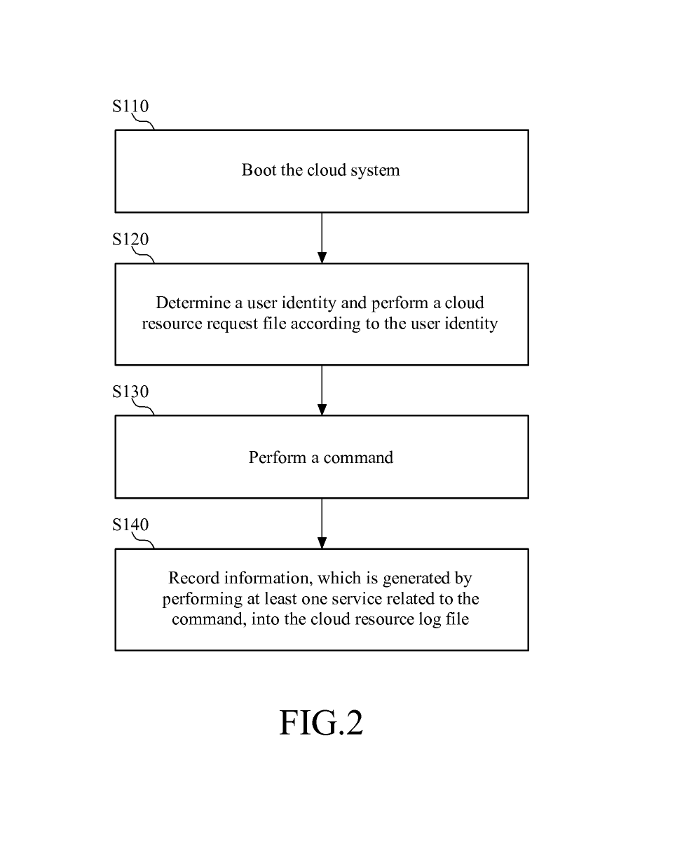

In one or more of the exemplary embodiments, after the cloud service provider 15 receives the cloud resource request file, the cloud service provider 15 performs a cloud resource allocation method, as shown in FIG. 2. FIG. 2 is a flowchart of a cloud resource allocation method in one of exemplary embodiments of the disclosure. As shown in step S110, boot the cloud system. As shown in step S120, determine a user identity and perform a cloud resource request file according to the user identity. As shown in step S130, perform a command. As shown in step S140, record information, which is generated by performing at least one service related to the command, into the cloud resource log file.

The user identity in step S120 can be, for example, the department, position or authority of the user, an administrator, or a tester. The command in step S130 can, for example, be encapsulated in the cloud resource request file or be inputted by the user. The cloud resource log file in step S140 can be, for example, a cloud resource log (e.g. a network security policy, a assess code, a public internet protocol (IP) address, a private IP address, a volume size, a storage name, a host name, a size, an image file name, an operation system (OS) name, a physical machine or their any possible combination for a VM) generated by performing at least one service related to the command.

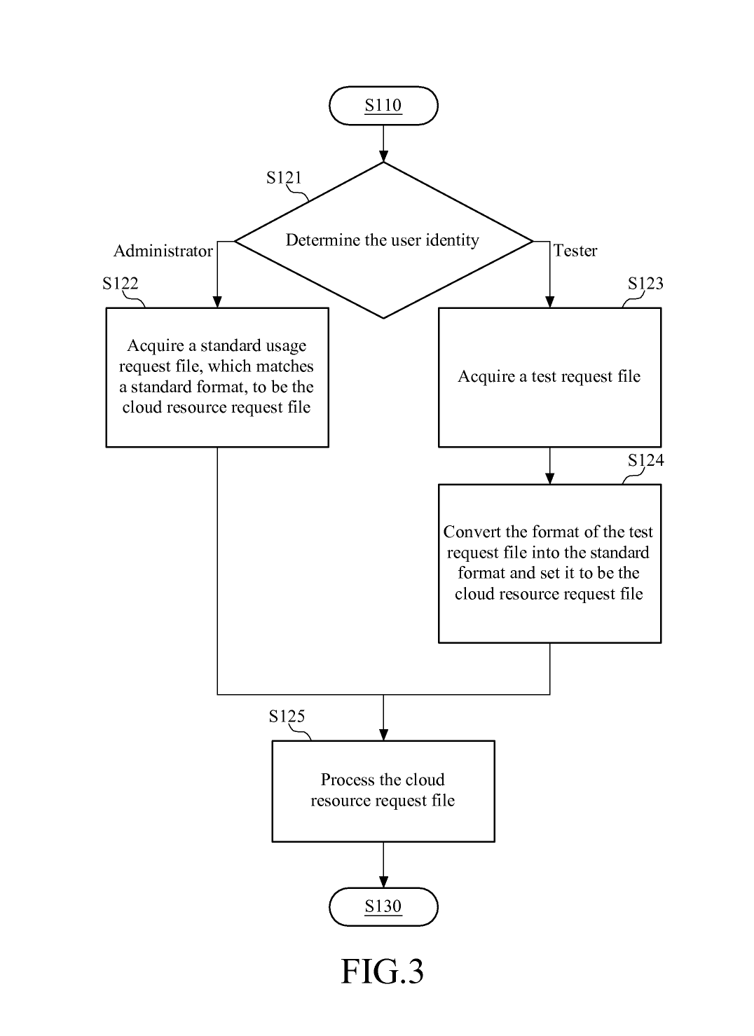

In one exemplary embodiment of step S120, the detail of the step S120 is shown in FIG. 3. FIG. 3 is a flowchart of the step S120 in FIG. 2 in one of the exemplary embodiments. As shown in step S121, determine the user identity. As shown in step S122, acquire a standard usage request file, which matches a standard format, to be the cloud resource request file when the user identity is an administrator. As shown in step S123, acquire a test request file when the user identity is a tester. As shown in step S124, convert the format of the test request file into the standard format and set it to be the cloud resource request file. As shown in step S125, process the cloud resource request file.

The standard usage request file includes, for example, a service category (e.g. an account, an identifier, a VM or an image file), data specifying actions (e.g. generating, deleting or no action), an authorized user name, an authorized user password, an authorized tenant name, a VM size (e.g. a number of virtual CPUs or a memory size), a service name (e.g. MySQL, Apache, Hadoop or LAMP), a volume size, a public IP address, and a preset security and network security rule for defining the security rule of firewall and the assess code for the VM.

The test request file includes, for example, first names of users, a number of users, first names of roles, a number of roles, first names of tenants, a number of tenants, first names of image files, a number of image files, first names of VM's and a number of VM's. When the test request file is converted into the standard usage request file, a corresponding number of users can automatically be set according to the first names of users and the number of users. In one exemplary embodiment, assume the first names of users are “John,” and a number of these users is 3. The main control device 13 generates a standard usage request file in which the authorized user names and passwords are automatically set to be “John1”, “John2” and “John3”. Thus, the standard usage request file can be used for testing the three users. Similarly, a corresponding number of roles can automatically be set according to the first names of roles and the number of roles, a corresponding number of tenants can automatically be set according to the first names of tenants and the number of tenants, and the rest can be deduced by analogy.

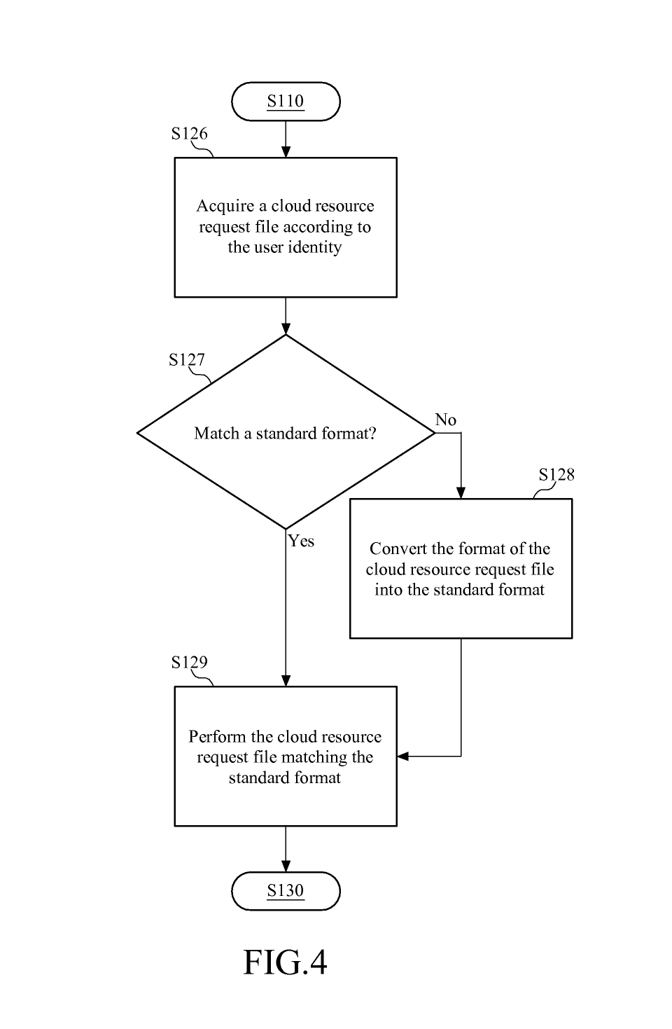

In alternate exemplary embodiment of step S120, the detail of the step S120 is shown in FIG. 4. FIG. 4 is a flowchart of the step S120 in FIG. 2 in one of the exemplary embodiments. As shown in step S126, acquire a cloud resource request file according to the user identity. The user identity includes, for example, user's department, position and authority. As shown in step S127, determine whether the format of the cloud resource request file matches a standard format. As shown in step S128, convert the format of the cloud resource request file into the standard format when the format of the cloud resource request file does not match the standard format. As shown in step S129, perform the cloud resource request file matching the standard format.

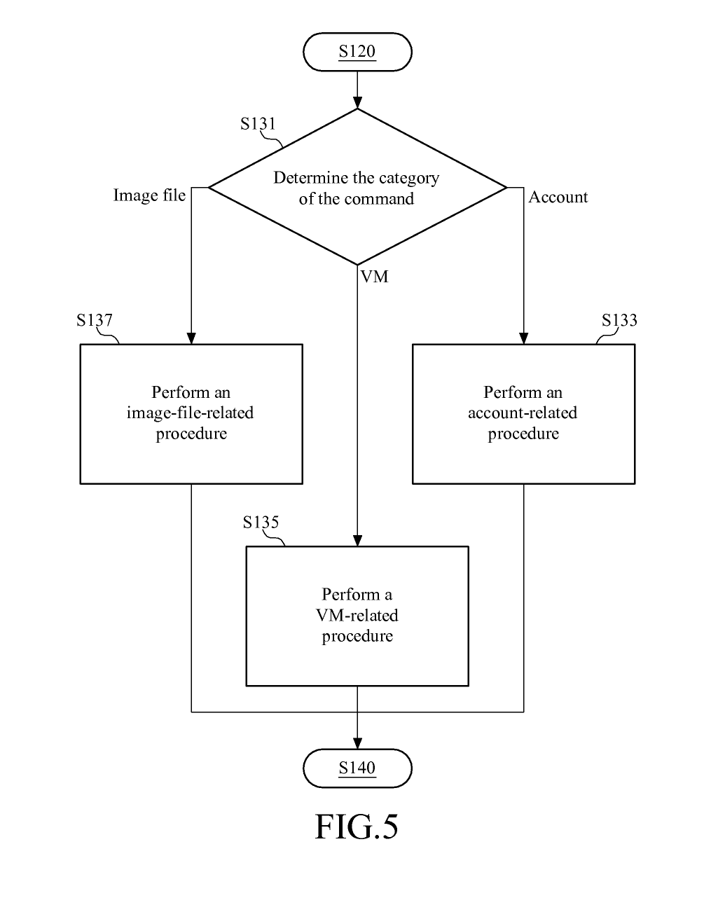

In one exemplary embodiment of step S130, the detail of the step S130 is shown in FIG. 5. FIG. 5 is a flowchart of the step S130 in FIG. 2 in one of the exemplary embodiments. As shown in step S131, determine the category of the command. As shown in step S133, perform an account-related procedure when the command is an account-related command. As shown in step S135, perform a VM-related procedure when the command is a VM-related command. As shown in step S137, perform an image-file-related procedure when the command is an image-file-related command.

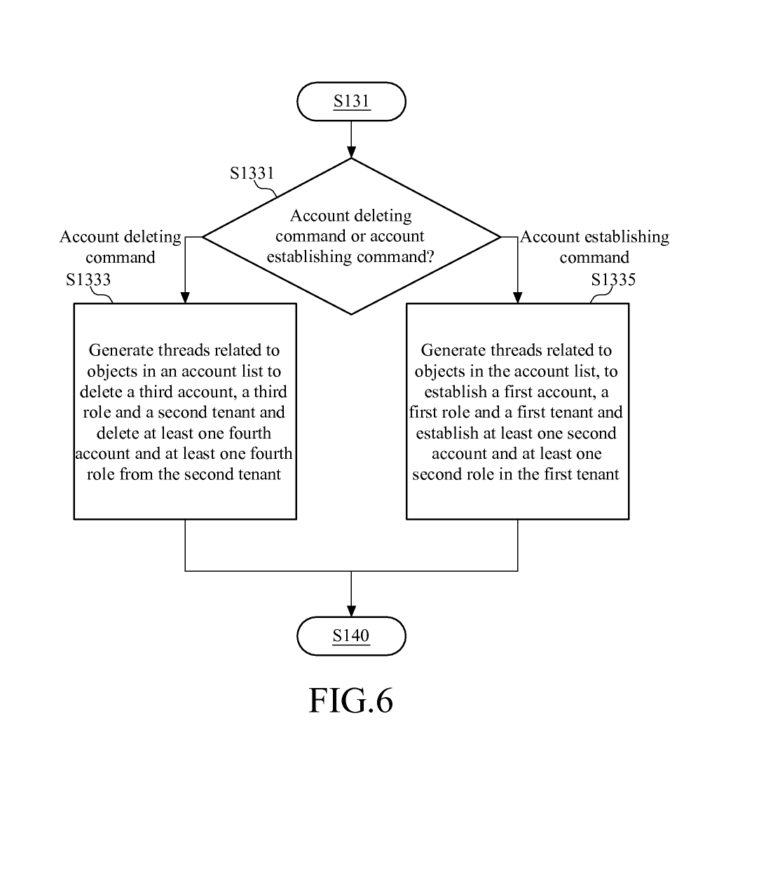

In one exemplary embodiment of step S133, the detail of the step S133 is shown in FIG. 6. FIG. 6 is a flowchart of the step S133 in FIG. 5 in one of the exemplary embodiments. As shown in step S1331, determine whether the command is an account deleting command. As shown in step S1333, generate threads related to objects in an account list to delete a third account, a third role and a second tenant and delete at least one fourth account and at least one fourth role from the second tenant when the command is the account deleting command. As shown in step S1335, generate threads related to objects in the account list, to establish a first account, a first role and a first tenant and establish at least one second account and at least one second role in the first tenant when the command is the account establishing command.

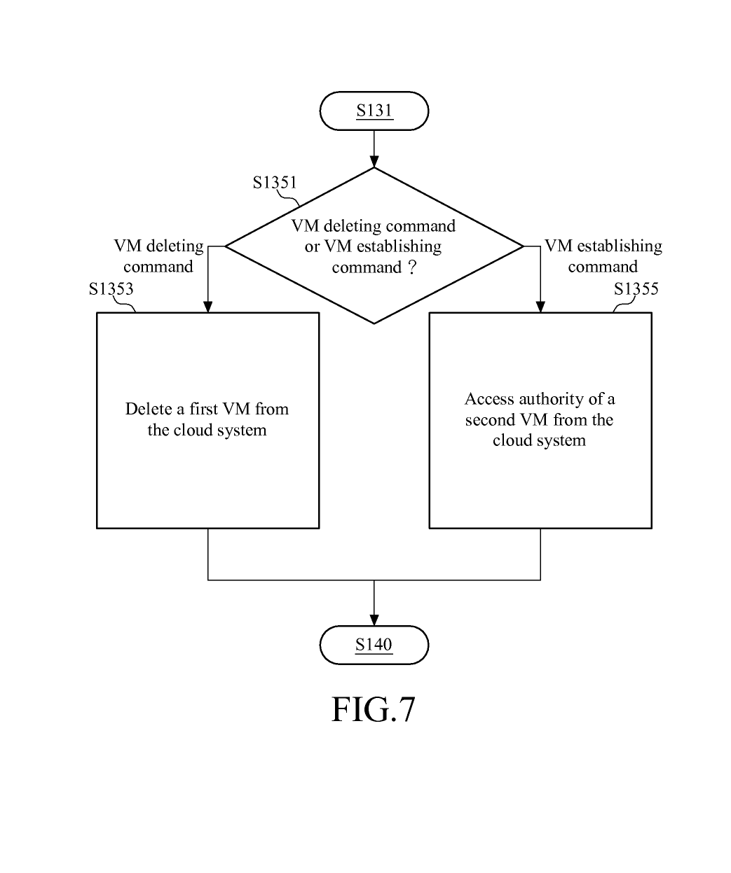

In one exemplary embodiment of step S135, referring to FIG. 7, determine whether the command is a VM deleting command, as shown in step S1351. As shown in step S1353, delete a first VM from the cloud system when the command is the VM deleting command. As shown in step S1355, assess authority of a second VM from the cloud system when the command is a VM establishing command.

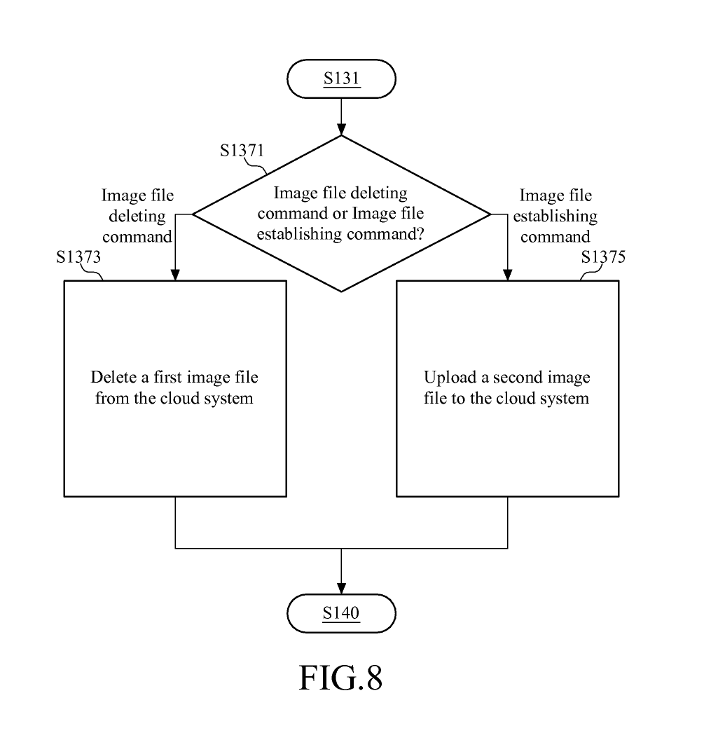

In one exemplary embodiment of step S137, the detail of the step S137 is show in FIG. 8. FIG. 8 is a flowchart of the step S137 in FIG. 5 in one of the exemplary embodiments. As show in step S1371, determine whether the command is an image file deleting command. As show in step S1373, delete a first image file from the cloud system when the command is the image file deleting command. As show in step S1375, upload a second image file to the cloud system when the command is an image file establishing command.

In view of the aforementioned exemplary embodiments, after recording the usage history of the user into the cloud resource request file, the disclosure can perform a corresponding cloud resource request file according to the user identity. Thus, the cloud system in the disclosure may efficiently provide the user with a required cloud resource or remove the cloud resource that the user does not need.

What is claimed is:

1. A cloud system, comprising:
an information database, configured to store user information;
a main control device, electrically connected to the information database and configured to acquire a cloud resource request file from the information database according to a name or category of a user;
a virtual machine database, configured to store at least one virtual machine image file; and
a cloud service provider, electrically connected to the main control device and the virtual machine database, and configured to acquire the at least one virtual machine image file from the virtual machine database according to the cloud resource request file, to provide a cloud service corresponding to the cloud resource request file.

2. The cloud system according to claim 1, wherein the main control device establishes the cloud resource request file according to at least one piece of basic information related to the user when the main control device can not acquire the cloud resource request file, related to the name or category of the user, from the information database.

3. The cloud system according to claim 2, wherein after establishing the cloud resource request file, the main control device determines whether there is a virtual machine image file corresponding to the cloud resource request file in the cloud service provider, and when there is no virtual machine image file in the cloud service provider, the main control device adds an image file establishing command in the cloud resource request file.

4. The cloud system according to claim 1, wherein while the cloud resource request file is a test request file, the cloud service provider converts the test request file into a standard usage request file.

5. A cloud resource allocation method, comprising:
processing a cloud resource request file according to a user identity to acquire resources from a cloud system;
performing a command; and
recording information, which is generated by performing at least one service related to the command, into a cloud resource log file.

6. The cloud resource allocation method according to claim 5, wherein to process the cloud resource request file according to the user identity comprises:
determining the user identity;
acquiring a standard usage request file, which satisfies a standard format, to be the cloud resource request file when the user identity is an administrator;
acquiring a test request file and converting a format of the test request file into the standard format to set the test request file to be the cloud resource request file when the user identity is a tester; and
processing the cloud resource request file.

7. The cloud resource allocation method according to claim 5, wherein to performing the cloud resource request file according to the user identity comprises:
acquiring the cloud resource request file according to the user identity;
determining a format of the cloud resource request file;
converting the format of the cloud resource request file into a standard format when the format of the cloud resource request file does not match the standard format; and
performing the cloud resource request file which matches the standard format.

8. The cloud resource allocation method according to claim 5, wherein to perform the command comprises:
determining whether the command is an account deleting command when the command is an account-related command;
generating threads, which are related to objects in an account list, to establish a first account, a first role and a first tenant and establish at least one second account and at least one second role in the first tenant when the command is an account establishing command; and
generating threads, which are related to objects in the account list, to delete a third account, a third role and a second tenant and delete at least one fourth account and at least one fourth role in the second tenant when the command is the account deleting command.

9. The cloud resource allocation method according to claim 5, wherein to perform the command comprises:
determining whether the command is an image file deleting command when the command is an image-file-related command;
deleting a first image file from the cloud system when the command is the image file deleting command; and
uploading a second image file to the cloud system when the command is an image file establishing command.

10. The cloud resource allocation method according to claim 5, wherein to perform the command comprises:
determining whether the command is a virtual machine deleting command when the command is a virtual-machine-related command;
deleting a first virtual machine in the cloud system when the command is the virtual machine deleting command; and
acquiring a second virtual machine from the cloud system when the command is a virtual machine establishing command.
